(19) United States
(12) Patent Application Publication
(10) Pub. No.: US 2014/0265478 A1
(43) Pub. Date: Sep. 18, 2014

(54) VEHICLE SEAT ADJUSTMENT INDICATOR

(71) Applicants: Andrew Schultz, Reyonldsburg, OH (US); Robert A. Maston, Columbus, OH (US)

(72) Inventors: Andrew Schultz, Reyonldsburg, OH (US); Robert A. Maston, Columbus, OH (US)

(73) Assignee: COMMERCIAL VEHICLE GROUP, INC., New Albany, OH (US)

(21) Appl. No.: 13/922,642

(22) Filed: Jun. 20, 2013

Related U.S. Application Data
(60) Provisional application No. 61/784,105, filed on Mar. 14, 2013.

(51) Int. Cl. B60N 2/44; B60N 2/02

(52) U.S. Cl. CPC B60N 2/44; B60N 2/02
USPC 297/217.4; 297/217.1; 297/217.3; 297/217.6

(57) ABSTRACT

An adjustable seat indicating assembly is provided and includes a stationary component attached to a stationary part of an adjustable seat assembly, a movable component attached to a movable part of the adjustable seat assembly, and an indicating component that changes state upon an interaction between the stationary component and the movable component, wherein the indicating component indicates that the movable part of the seat is in a desired seating position.

### CROSS-REFERENCE TO RELATED APPLICATIONS

This application claims the benefit of U.S. Provisional Patent application Ser. No. 61/784,105 entitled “VEHICLE SEAT ADJUSTMENT INDICATOR” filed on Mar. 14, 2013. The entirety of the above-noted application is incorporated by reference herein.

### ORIGIN

The innovation disclosed herein relates to a vehicle seat and more specifically, to a vehicle seat adjustment indicator.

### BACKGROUND

It is well-known to provide a vehicle seat, in particular in a long-haul or heavy goods vehicle, where a seat base is mounted to a floor of the vehicle and a movable seat part is mounted on the seat base. A suspension (e.g., spring, air, gas, etc.) isolates some of the vibration experienced by the vehicle cab and hence the seat base from the movable seat part.

In addition, the movable seat part moves in both a vertical and horizontal direction with respect to the seat base. The driver typically adjusts the movable seat part to achieve a desired seating position or to achieve a mid-ride position, which is a position of the seat approximately halfway between the up and down position of the seat.

Mechanical seat indicators are used to assist the driver in obtaining the desired seating position. Mechanical indicators, however, have several drawbacks. First, they are subject to tolerance and, thus, not very accurate. Second, the mechanical indicators are mounted to the seat and, thus, are not visible to the driver of the vehicle. Another drawback is that the mechanical indicators are exclusive to the seat assembly. Thus, a separate mechanical indicator needs to be manufactured for each seat assembly, which is costly and does not lend itself to flexibility.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In an aspect of the innovation, an adjustable seat indicating assembly is provided and includes a stationary component attached to a stationary part of an adjustable seat assembly, a movable component attached to a movable part of the adjustable seat assembly, and an indicating component that changes state upon an interaction between the stationary component and the movable component, wherein the indicating component indicates that the movable part of the seat is in a desired seating position.

In another aspect of the innovation, a seat assembly for a vehicle is provided and includes a stationary part attached to a floor of the vehicle, a movable part attached to the stationary part and movable with respect to the stationary part, and an adjustable seat indicating assembly that informs occupant(s) when the movable part is in a desired seating position.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a perspective view of a vehicle seat assembly incorporating an innovative adjustable seat indicating assembly in accordance with an aspect the innovation.

FIGS. 2A-2F are a block diagrams illustrating an example embodiment of components of the adjustable seat indicating assembly in accordance with an aspect the innovation.

FIG. 3 is an example embodiment of an electrical circuit assembly of the adjustable seat indicating assembly in accordance with an aspect the innovation.

FIG. 4 is a flow chart illustrating a method of operation of the adjustable seat indicating assembly in accordance with an aspect the innovation.

FIG. 5 is a block diagram of another example embodiment illustrating components of the adjustable seat indicating assembly communicating with a self-leveling system in accordance with an aspect of the innovation.

FIGS. 6A and 6B are block diagrams of another example embodiment illustrating components of the adjustable seat indicating assembly including a memory adjustment device in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Vehicle seat assemblies in, for example, long-haul trucks, are adjustable in a vertical and horizontal direction, such that occupants of the vehicle can adjust the seat in a desired seating position. The innovation disclosed herein incorporates an adjustable seat indicating assembly that informs the occupants when the seat is in the desired seating position. The desired seating position may or may not be what is referred to as a “mid-ride” or “ride” position, which is halfway between the up and down position of the seat. Thus, the innovation can be utilized to inform the occupant(s) when the seat assembly is in any desired seating position or in the mid-ride seating position.

With reference now to the figures, FIG. 1 is a perspective illustration of a seat assembly 100 for a vehicle incorporating an adjustable seat indicating assembly 200 in accordance with an aspect of the innovation. The seat assembly 100 includes a stationary part (seat frame) 102 typically attached to a floor of the vehicle and a movable part (seat) 104 that moves in multiple directions (e.g., vertical, horizontal, tilt forward and rearward at an angle, etc.) with respect to the stationary part 102. As will be explained in more detail further below, the adjustable seat indicating assembly 200 changes state thereby informing occupant(s) of the vehicle when the movable part 104 of the seat assembly 100 is in the desired seating position.

Referring to FIG. 2A, the adjustable seat indicating assembly 200 includes a stationary component 210, a movable component 230, an indicating component 240, a power source 250, and optionally a timer 260.

Referring to FIG. 2B, the stationary component 210 attaches to the stationary part 102 of the seat assembly 100 and includes an attachment part 212 and an activating device 214. The attachment part 212 is a support type device, such as but not limited to a bracket, brace, fastener, etc., that provides a means to attach the activating device 214 to the stationary part 102 of the seat assembly 100. The attachment part 212 may be made from a rigid or semi-rigid material, such as but not limited to, plastic, metal, rubber, etc.

The activating device 214 is an electrical circuit assembly 218 that includes an electrical circuit 220 mounted to a circuit board 222. The electrical circuit assembly 218 provides a means to trigger the indicating component 240 upon interaction between the stationary component 210 and the movable component 230 explained further below.

FIG. 3 is an illustration of one example embodiment of an electrical circuit assembly 300 in accordance with an aspect of the innovation. In the embodiment illustrated in FIG. 3, an electrical circuit 302 is mounted to a circuit board 304 and functions a magnetic switch that when subjected to a magnet triggers the indicating component 240. It is to be understood, that the example embodiment illustrated in FIG. 3 is not intended to limit the scope of the innovation and is, thus, intended only for illustrative purposes.

Referring to FIG. 2C, the movable component 230 is attached to the movable part 104 of the seat assembly 100 and includes an attachment part 232 and an actuation device 234. The attachment part 232 is a support type device, such as but not limited to a bracket, brace, fastener, etc., that provides a means to attach the actuation device 234 to the movable part 104 of the seat assembly 100. The attachment part 232 may be made from a rigid or semi-rigid material, such as but not limited to, plastic, metal, rubber, etc.

The actuation device 234 is a device that interacts with the activating device 214 of the stationary component 210 to thereby trigger the indicating component 240 upon interaction between the stationary component 210 and the movable component 230 explained further below. One example embodiment of an actuation device 234 is a magnet 236. The magnet 236 attaches to the attachment part 232 of the movable component 230. In one example embodiment, the magnet 236 may be attached to a distal end on an extended part on the attachment part 232 of the movable component 230.

Referring to FIG. 2D, the indicating component 240 that, as mentioned above, changes state upon an interaction between the stationary component 210 and the movable component 230, such that the change in state informs the occupant(s) that the movable part 104 of the seat assembly 100 is in the desired seating position. In order to change state, the indicating component 240 is first initiated thereby entering an initiation state. The initiation state occurs when the occupant(s) initiate movement of the seat assembly 100 to achieve the optimum seating position. The initiation state may be initializing the indicating component 240 by simply sending a signal to the indicating device that the occupant(s) is initiating adjustment of the seat assembly 100. In other aspects, the initiation state may be illuminating a light source, activating an audible device or a vibrating device. Once the seat assembly 100 is in the optimum seating position, the indicating component 240 enters a second or confirmation state. In the second state, the indicating component 240 changes state by either turning on, turning off, intensifying, changing color, etc.

The indicating component 240 may include additional states (e.g., third state, fourth state, etc.) that informs the occupant(s) that the seat assembly 100 is in other positions (e.g., above or below the optimum seating position). The indicating component 240 can be any type of component or device, or a combination thereof that is capable of providing a confirmation to the occupant that the movable part 104 of the seat assembly 100 is in the optimum seating position.

For example, still referring to FIG. 2D, in one embodiment, the indicating component 240 can be a light source 242 that illuminates upon activation of the indicating component 240. The light source 242 may be any type of light source, such as but not limited to, LED's. In one aspect, one light source 242 may be employed that will illuminate, intensify, or fade when the movable part 104 of the seat assembly 100 is in the optimum seating position. In another aspect, the light source 242 may change colors when the movable part 104 of the seat assembly 100 is in the optimum seating position. In yet another aspect, multiple light sources may be employed each having a different color where one light source illuminates during the seat adjustment process and another light source illuminates when the movable part 104 of the seat assembly 100 is in the optimum seating position. In still yet another aspect, the multiple light sources may also include indications for when the movable part 104 is above or below the mid-ride position.

Still referring to FIG. 2D, in another example embodiment, the indicating component 240 can be an audible device 244 that emits a sound that emits a sound when the movable part 104 of the seat assembly 100 is activated and silences upon activation of the indicating component 240. In another aspect, the audible device 244 may be silent upon activation of the movable part and then emit a short continuous or pulsed sound upon activation of the indicating component 240.

Still referring to FIG. 2D, in another example embodiment, the indicating component 240 can be a vibration device 246 that vibrates (or ceases to vibrate) upon activation of the indicating component 240.

It is to be understood, that the example embodiments of the indicating components 240 described above and illustrated in the figures are not intended to limit the scope of the innovation and are, thus, intended for only illustrative purposes.

Referring to FIG. 2E, the power source 250 drives the electrical circuit and in one embodiment may be in the form of a battery 252 attached to the circuit board 304 illustrated in the example embodiment in FIG. 3. In this embodiment, the operation of the adjustable seat indicating assembly 100 is not dependent on an external power, since the battery 252 is attached to the circuit board. In another embodiment, the electrical circuit may be driven by an external or remote power source 254, such as but not limited to a vehicle battery or other power sources associated with the vehicle.

Referring to FIG. 2F, the adjustable seat indicating assembly 200 may include an optional timer 260. In one example embodiment, the timer may be part of the electrical circuit assembly 218, such that the timer 260 is mounted to the circuit board 222 and activated remotely by the occupant. In another example embodiment, the timer 260 may be remote from the electrical circuit assembly 218. The timer 260 is actuated by the occupant via a button, switch, etc. and that when actuated, activates (e.g., illuminates) the indicating component 240. The timer 260 activates the indicating component 240 for a predetermined period of time to allow the occupant to adjust the movable part 104 of the seat assembly 100 to the desired seating position. For example, in the embodiment where the indicating component 240 is a light source 242, when the occupant actuates the timer via the button, switch, etc., the light source will illuminate for the predetermined period of time to allow the occupant time to adjust the seat assembly to the optimum seating position. Once the timer 260 expires the light source 242 will turn off thereby prolonging the life of the light source 242 and the power source 250.

Referring to FIG. 4, operation of the adjustable seat assembly 200 will now be described. At 402, an optional timer 260 may be activated. The timer 260 permits the occupant to successfully adjust the seat assembly 100 to the desired seating position, as described above. It is to be understood, that the timer 260 is an optional feature of the innovation and that the timer 260 is not required in the operation of the innovation. At 404, the indicating component 240 is initialized or enters a first state, as described above. For example, if the indicating component 240 is a light source, the light source may illuminate in a first color. At 406, the movable part 104 of a seat assembly 100 is adjusted or moved with respect the stationary part 102 of the seat assembly 100. At 408, the movable component 230, which is attached to the movable part 104 of the seat assembly 100, moves to interact with the stationary component 210, which is attached to the stationary part 102 of the seat assembly 100. At 410, the actuation device 234 on the movable component 230 interacts with the activating device 214 on the stationary component 210. At 412, once the movable part 104 of the seat assembly 100 is in the desired seating position, the indicating component 230 enters a second state thereby confirming that the seat assembly 100 is in the desired seating position. For example, if the indicating component 230 is a light source, the light source may change color, intensify, fade, illuminate additional light sources, etc., as described above.

Referring to FIG. 5, in another embodiment, the seat assembly 100 may include a self-leveling system 500 that includes a solenoid valve 502 and a compressor 504 in accordance with an aspect of the innovation. The adjustable seat indicating assembly 200 can communicate with and trigger (if desired) the self-leveling system 500, as described herein, to automatically adjust the seat assembly 100 to the optimum seating position. In one example embodiment, a 2-way solenoid valve can be utilized with a seat assembly having a seat compressor or in another example embodiment, a 3-way solenoid valve can be utilized where the seat assembly operates off the vehicle's compressor.

Sensor signals may be communicated between the adjustable seat indicating assembly 200 and the self-leveling system 500 to activate and deactivate the solenoid 502 or the compressor 504 to add or remove air to thereby adjust the seat assembly into the optimum seating position. Once the seat assembly 100 is properly adjusted, via the self-leveling system 500, the indicating component 240 can activate as described herein to thereby alert the occupant that the seat assembly 100 is in the optimum or desired position.

Referring to FIGS. 6A and 6B, the adjustable seat indicating assembly 200 may include a memory adjustment device 600 where one or more users may store a seat position in the memory adjustment device 600 for future use. The memory adjustment device 600 includes a memory 602, one or more switches or buttons (i.e., memory switch) 604 and may include one or more indicators 606. Once a user has the seat assembly 100 positioned in a desired seating position, the user can store the seat position in the memory 602 via the one or more switches 604. This seating position is stored in the memory 602 for future use. Thus, the user simply needs to activate the appropriate switch 604 and the seat assembly 100 will automatically adjust the seat assembly to that user's desired seat position. The optional one or more indicators 606 may indicate when the desired seat position is stored in memory 602 and may also indicate when the seat assembly 100 is in the desired seating position.

In another embodiment, the adjustable seat indicating assembly 200 may include an application of applet in accordance with an aspect of the innovation. Thus, the occupant(s) can be notified of the state of the indicating component on an electronic device.

The above described adjustable seat indicating assembly overcomes the disadvantages of the mechanical indicators mentioned above. For example, the adjustable seat indicating assembly is an electronic device, which is more accurate than the mechanical devices mentioned above. The indicating component of the adjustable seat indicating assembly disclosed herein can be located at any location in the cab of the vehicle and, thus, can be placed at a location that is readily visible to the occupant(s). Further, the adjustable seat indicating assembly is flexible and can be used on multiple seat configurations by simply changing the attachment part.

It is to be understood, that the innovation disclosed herein has many applications and is not limited long-haul or heavy goods vehicles. More specifically, the innovation may be applied to any vehicle having an adjustable seat assembly. For example, the innovation may be applied to transport trucks, lighter duty trucks, box trucks, flatbed trucks, sprinter trucks, pick-up trucks, vans, busses, RVs, agriculture equipment (e.g., tractors, excavators, etc.), etc.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. An adjustable seat indicating assembly comprising:
a stationary component attached to a stationary part of an adjustable seat assembly;
a movable component attached to a movable part of the adjustable seat assembly; and
an indicating component that changes state upon an interaction between the stationary component and the movable component, wherein the indicating component indicates that the movable part of the seat is in a desired seating position.

2. The adjustable seat indicating assembly of claim 1 further comprising a timer, wherein the indicating component is initialized upon activation of the timer.

3. The adjustable seat indicating assembly of claim 1, wherein the stationary component includes an electrical circuit assembly that changes the state of the indicating component upon the interaction between the stationary component and the movable component.

4. The adjustable seat indicating assembly of claim 3, wherein the movable component includes an actuating device adapted to interact with the electrical circuit assembly thereby changing the state of the indicating component upon the interaction between the stationary component and the movable component.

5. The adjustable seat indicating assembly of claim 3, wherein the electrical circuit assembly includes an electrical circuit that includes a battery that powers the circuit and a magnetic switch, and the actuating device includes a magnet, and wherein interaction between the magnetic switch and the magnet changes the state of the indicating component.

6. (canceled)

7. The adjustable seat indicating assembly of claim 1, wherein the indicating component is a light source that illuminates when the indicating component changes state.

8. The adjustable seat indicating assembly of claim 1, wherein the indicating component is a light source that changes color when the indicating component changes state.

9. The adjustable seat indicating assembly of claim 1, wherein the indicating component is an audible device that emits a sound when the indicating component changes state.

10. The adjustable seat indicating assembly of claim 1, wherein the indicating component is an audible device that emits a sound when the movable part of the seat is activated and silences when the indicating component changes state.

11. The adjustable seat indicating assembly of claim 1, wherein the indicating component is a vibrating device that vibrates when the indicating component changes state.

12. A seat assembly for a vehicle comprising:
a stationary part attached to a floor of the vehicle;
a movable part attached to the stationary part and movable with respect to the stationary part; and
an adjustable seat indicating assembly that informs occupant(s) when the movable part is in a desired seating position.

13. The seat assembly of claim 12, wherein the adjustable seat indicating assembly includes a stationary component attached to the stationary part, a movable component attached to a movable part, and an indicating component that changes state upon an interaction between the stationary component and the movable component.

14. The seat assembly of claim 12 further comprising a timer, wherein the adjustable seat indicating assembly is initialized upon activation of the timer.

15. The seat assembly of claim 12, wherein the adjustable seat indicating assembly includes a magnetic switch and a magnet.

16. The seat assembly of claim 15, wherein one of the magnetic switch and the magnet is mounted to a stationary support attached to the stationary part of the seat assembly and wherein the other of the magnetic switch and the magnet is attached to a support attached to the movable part of the seat assembly.

17. The seat assembly of claim 16, wherein interaction between the magnetic switch and the magnet changes a state of the adjustable seat indicating assembly.

18. A method of adjusting a seat assembly in a vehicle comprising:
initializing an indicating component of an adjustable seat indicating assembly;
adjusting a movable part of a seat assembly with respect a stationary part of the seat assembly;
moving a movable component attached to the movable part of the seat assembly to interact with a stationary component attached to the stationary part of the seat assembly;
interacting an actuation device on the movable component with an activating device on the stationary component; and
changing a state of the indicating component when the seat assembly is in an optimum seating position.

19. The method of claim 18, wherein prior to activating an indicating component of an adjustable seat indicating assembly the method further comprising activating a timer.

20. The method of claim 19 further comprising deactivating the indicating component when one the timer expires.

21. The adjustable seat indicating assembly of claim 1 further comprising at least one sensor and a self-leveling system, wherein activation of the sensor automatically activates the self-leveling system that adjusts the movable part of the adjustable seat assembly into a desired seating position.
